(19) United States
(12) Patent Application Publication
(10) Pub. No.: US 2009/0204477 A1
(43) Pub. Date: Aug. 13, 2009

(54) Ink Cartridge Distribution System and Method

(76) Inventor: Anton E. Urso, Monona, WI (US)

Correspondence Address: MURPHY DESMOND S.C., P.O. BOX 2038, MADISON, WI, 53701-2038, US

(21) Appl. No.: 12/366,442

(22) Filed: Feb. 5, 2009

Related U.S. Application Data
(60) Provisional application No. 61/027,116, filed on Feb. 8, 2008.

(51) Int. Cl. G06Q 10/00

(52) U.S. Cl. 705/10; 705/7

(57) ABSTRACT

The present invention is directed to a method and system of scheduling the delivery of printer cartridges to businesses that minimizes the number of cartridges that a business needs to stock and the likelihood that a printer will not have a compatible cartridge when it runs out of ink or toner. The method comprises conducting a survey of the printers in a business and the consumption of ink cartridges by the printers. The data is used to calculate a schedule for the manufacture or remanufacture, distribution and storage of cartridges for the business. At a scheduled time, a remanufacturer is contacted to remanufacture cartridges that are needed by the business. Optionally, if recyclable cartridges are not available, an original equipment manufacturer (OEM) is contacted to provide a replacement cartridge. The cartridges may be delivered a distribution center, which then delivers the cartridges to the business, or may be delivered directly to the client. At the time of delivery, consumed cartridges are collected from the business and the survey of equipment and cartridge consumption is updated. Where there is a change in the survey, the new data is used to calculate an updated schedule.

### RELATED APPLICATION

The present invention claims priority from and is a continuation-in-part of U.S. Provisional Patent Application 61/027,116 filed Feb. 8, 2008.

### BACKGROUND OF THE INVENTION

The present invention relates generally to the distribution of ink cartridges for use in printers, copiers, facsimile machines and multifunctional variations thereof.

Printers, copiers, facsimile machines, and/or multifunctional variations thereof have become indispensable components of the modern office (hereinafter they may be collectively referenced as “printer” or “printers”). One common feature of many modern printers is that they consume ink and toner that are supplied by ink cartridges, such as all-in-one ink and toner cartridges that are single, self-contained, replaceable vessels for delivering ink and toner to printers. However, there are a number of different types of cartridges that contain combinations of ink and/or toner. Whether a cartridge delivers ink, toner or a combination thereof and whether the cartridge is to be used in a printer, copier, facsimile machine or a multifunctional variation thereof, for purposes of this disclosure it will be referenced as a cartridge or an ink cartridge.

The convenience of printers can be off-set when they fail to operate or “go down.” When even one printer goes down, the productivity of the office may slow down and in smaller offices may even grind to a halt. Although there are numerous reasons for printers to fail, a common reason for a printer to fail is simply that the printer has run out of ink or toner. Most offices recognize this eventuality and stock backup cartridges. However, it is not uncommon for a backup cartridge to be stored too long, for an office to not have stocked enough cartridges, or for an office to fail to stock all of the different cartridges needed to service all of the different printers used in the office.

In addition, although ink cartridges provide a convenient method of delivering the ink and toner to printers, unrecycled cartridges have become a landfill problem. In response, many businesses have begun to recycle cartridges by refilling the cartridges after the ink and toner have been expended (“remanufacturing”). Remanufacturing is most often done by third-party remanufacturers, and not by the businesses themselves. However, many businesses recycle ink cartridges on an as-needed basis. This further complicates the cartridge stockpiling problems described above. Unless the business has stocked spare cartridges for a particular printer, the business may not be able to use that printer until its cartridge is remanufactured. However, the stockpiling of extra cartridges may detract from the business's effort to recycle the cartridges.

The present invention provides a systematic method of tracking, aging, remanufacturing and delivering cartridges. Some benefits of the inventive distribution method and system include limiting the occasions when a printer goes down, limiting the occasions when a cartridge is stored too long, and providing for the recycling of cartridges without an adverse effect on the productivity of the printers.

### BRIEF SUMMARY OF THE INVENTION

The present invention is directed to a method and system of scheduling the delivery of printer cartridges to businesses that minimizes the number of cartridges that a business needs to stock and the likelihood that a printer will not have a compatible cartridge when it runs out of ink or toner. The method comprises conducting a survey of the printers in a business and the consumption of ink cartridges by the printers. Such a survey may be initiated by keeping track of the use of cartridges by each printer or by reviewing records of historical cartridge purchases. The data is used to calculate a schedule for the manufacture or remanufacture, distribution and storage of cartridges for the business. At a scheduled time, a remanufacturer is contacted to remanufacture cartridges that are needed by the business. Optionally, if recyclable cartridges are not available, an original equipment manufacturer (OEM) is contacted to provide a replacement cartridge. The cartridges may be delivered to a distribution center, which then delivers the cartridges to the business, or may be delivered directly to the client. At the time of delivery, consumed cartridges are collected from the business and the survey of equipment and cartridge consumption is updated. Where there is a change in the survey, the new data is used to calculate an updated schedule.

### BRIEF DESCRIPTION OF THE DRAWINGS

FIG. 1 is a block diagram of an embodiment illustrating the invention.

### DETAILED DESCRIPTION OF THE INVENTION

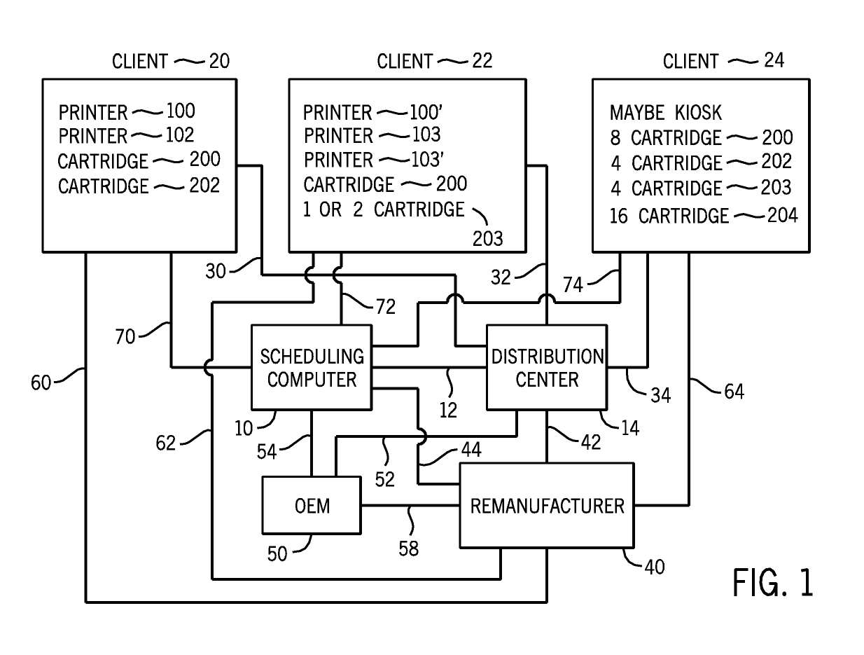

In FIG. 1, an embodiment of the system according to the invention is shown with a scheduling computer 10 linked by connection 12 to distribution center 14 which services a number of clients 20, 22 and 24 through channels 30, 32 and 34, where client 24 is optionally a self-service kiosk, which is optionally a vending machine capable of delivering cartridges 24 hours a day and seven days a week. For purposes of the present disclosure, the term connection is selected from the group consisting of a hardwire electronic connection, a wireless electronic connection, physical presence of computer 10 in or proximate to distribution center 14 such that the output of computer 10 can be transmitted to and used by the distribution center, and combinations thereof. A hardwire electronic connection can include the transmission of data through optical fibers and other means known in the art.

Herein, the term channel encompasses a communication system and/or a distribution system. Channels 30, 32 and 34 connects the clients and the distribution center so that they may communicate and provide for the delivery of charged cartridges from the distribution system to the clients and the collection of consumed cartridges from the clients to the distribution system. In an embodiment, channels 30, 32 and 34 are represented by a technician who according to a schedule calculated by the computer delivers the cartridges, surveys the printers and the cartridges used by the client, and collects and returns the consumed cartridges to the distribution center. In another embodiment, cartridges are delivered and collected by a delivery service such as the post office or a private parcel service according to a schedule calculated by the computer. In this embodiment, the client accepts delivery of the charged cartridges and collects and returns the consumed cartridges along with a survey of printers and consumed cartridges.

Distribution center 14 is further connected to remanufacturer 40 by channel 42 and to OEM 50 by channel 52. Similar to the previously described channels, channels 42 and 52, the channels encompass a communication system and a delivery system which provides the means by which the distribution center can order and take delivery of either recharged cartridges or new cartridges from the remanufacturer or the OEM, respectively. For purposes of this disclosure both the remanufacturer and the OEM may be called cartridge makers, and although the remanufacturer actually recycles the cartridges, the cartridges may be referenced as new as if originally made by the OEM.

Optionally, remanufacturer 40 and OEM 50 are connected directly with computer 10 by connections 44 and 54, respectively. In this embodiment, remanufacturer 40 can receive orders directly from computer 10 to recharge a number of cartridges in accordance to the requirements calculated by the computer. Once an order is fulfilled, remanufacturer 40 can deliver the order to distribution center 14 via channel 42 for distribution center 14 to deliver the charged cartridges to the clients via channels 30, 32 and 34. Alternatively, once an order is fulfilled, remanufacturer 40 can deliver the order directly to the clients via channels 60, 62 and 64.

If remanufacturer 40 determines that one or more of the cartridges collected from the clients cannot be remanufactured, it may request replacement cartridges from alternative sources. In one case, it may notify computer 10 via connection 44 which then orders a replacement cartridge from OEM 50 via connection 54. OEM 50 then delivers the replacement cartridge via channel 58 for remanufacturer 40 to work into the rotation of cartridges that are recycled among the clients. In another case, remanufacturer 40 notifies distribution center 14 via channel 42, which orders a replacement cartridge from OEM 50 via channel 52, which fulfills the order by delivering the replacement cartridge to remanufacturer 40 via channel 58. In yet another embodiment, remanufacturer 40 orders and takes delivery of the replacement cartridge directly from OEM 50 via channel 58.

In a yet another embodiment, computer 10 is electronically linked to clients 20, 22 and 24 via connections 70, 72 and 74. The number and types of printers and cartridges used are automatically communicated to computer 10 which runs a constant calculation of an optimal schedule of the delivery and collection of cartridges from the clients. The computer can order cartridges in accordance to its calculations from remanufacturer 40 via connection 44. Remanufacturer 40 can fulfill the orders by directly delivering the orders to the clients or indirectly by delivering the orders to the distribution center.

In the case, where client 24 is a kiosk, it is apparent that the kiosk must be physically restocked. In this case, the kiosk can be restocked by a technician or an automaton from distribution center 14 or remanufacturer 40. Nevertheless, distribution of cartridge can be ascertained electronically, so that cartridges that do not move well can be replaced by more popular cartridges. The kiosk can also have an input device which allows consumers to order specific types of cartridges. The frequency of consumer requests can also be used to calculate what types of cartridges are more likely to be sold from the self-service kiosks.

The method according to the invention relies primarily on the survey of the client's printers and cartridge consumption, and the input of that data into the computer so that an optimal schedule of cartridge replacement can be calculated to minimize both printer down time and the need to stock too many cartridges. If done for a single client, it would be simple but inefficient. However, as the number of clients increase the complexity of the scheduling lo increases, but the overlap of the types of printers used by the clients can provide for efficiencies in rotating the cartridges for recycling. In addition, the economies of scale provides for greater efficiencies in the pricing, remanufacture and delivery of the cartridges.

The method is best illustrated by an example. It should be apparent that the example is only illustrative and not limiting. A survey is conducted of clients 20, 22 and 24. In this example, client 24 is a self-service kiosk. Client 20 has two different printers 100 and 102 requiring cartridges 200 and 202, respectively. It is estimated that both printers consume a cartridge every three weeks. Client 22 uses printer 100′ which is identical to printer 100 used by client 20, and identical printers 103 and 103′ which require cartridge 203. It is estimated that printer 100′ uses a cartridge about every five weeks, printer 103 uses a cartridge every 8 weeks, and printer 103′ uses a cartridge every 9 weeks. Based upon industry data, kiosk 24 is stocked with 8 units of cartridge 200, 4 units of cartridge 202, 4 units of cartridge 203 and 16 units of cartridge 204 (although not shown, in this example cartridge 204 is used in popular home printer 104). It is estimated that the Kiosk runs out of cartridge 204 in about 2 weeks, cartridge 200 in about two weeks, cartridge 202 in about 4 weeks, and cartridge 203 in about 8 weeks.

A software program is used to calculated how often each client is visited, which cartridges are to be delivered at each visit, how many cartridges need to be stocked for each client, and how many of each type of cartridges need to be delivered. The program assigns a frequency of visit to each client, a frequency of replacement for each cartridge, and the number of backup cartridges needed to make sure that a printer does not goes down from running out of ink or toner. In addition, based upon the frequency of visit to a client, the client is also assigned a rotation number to determine when a delivery should be made to the client.

Numerous scheduling options are available, including daily, weekly, monthly delivery frequencies. The frequencies can also be varied to optimize efficiency of delivery. For example, one can use a 60 day rotation, where deliveries and cartridge replacements can take place daily or every 2, 3, 4, 5, 6, 10, 12, 15, 20, 30 or 60 days. For purposes of this example, a 24 week frequency rotation having a rotation frequency of 1, 2, 3, 4, 6, 8, 12 or 24 weeks is illustrated. In the case of a 1 week frequency for replacement of, for example, cartridge 200 for client 20, cartridge 200 should be replaced every week. However, because of other factors, delivery to client 20 may not necessarily occur every week. If, for example, delivery to client 20 occurs every two weeks, the scheduling program would assign the delivery of two units of cartridge 200 every two weeks for client 20, and would assign the stockpiling of one cartridge 200 for client 20, where the backup cartridge 200 would be part of the turnover of cartridge 200 for the client 20.

From the examples above, and illustrated rotational frequency, client 20 is assigned a three week rotation for delivery of cartridges 200 and 202 and the stockpiling of one of each of cartridges 200 and 202 that is rotated into the turnover of the cartridges. Thus, for the initial delivery a cartridge will be installed in each of printers 100 and 102, and one of each cartridge 200 and 202 will be stocked in case the installed cartridges run out. Thus four cartridges are initially delivered. For a three week rotation there are three possible flights: 3A (weeks 1, 4, 7, 10, 13, 16, 19 and 22); 3B (weeks 2, 5, 8, 11, 14, 17, 20 and 23); and 3C (weeks 3, 6, 9, 12, 15, 18, 21 and 24). For this example, client 20 is assigned flight 3A on Mondays. Assuming that the initial delivery occurred on week 1, client 20 will receive a delivery of one cartridge 200 and one cartridge 202 on the Monday of week 4. The new cartridges replace the backup cartridges, the backup cartridges replace the installed cartridges, and the install cartridges (which we presume will be substantially exhausted) are collected for remanufacturing. The process is repeated on Monday of week 7, week 10 and so on. After week 24, the following weeks are labeled sequentially from 1-24, and the assigned flights are repeated. At any time, the schedule can be adjusted as printers are added, replaced or retired, or as cartridge consumption increase or decrease.

Client 22 would be assigned a four week frequency. For a four week rotation there are four possible flights: 4A (weeks 1, 5, 9, 13, 17 and 21); 4B (weeks 2, 6, 10, 14, 18 and 22); 4C (weeks 3, 7, 11, 15, 19 and 23); and 4D (weeks 4, 8, 12, 16, 20 and 24). Client 22 is assigned flight 4B on Mondays. The initial delivery on Monday of week 2 would be 2 units of cartridge 200 (one installed in printer 100′ and one stocked for printer 100′) and three units of cartridge 203 (one installed in each of printers 103 and 103′, and one as backup for both) for five initial cartridges. On Monday of week 6, only one unit of cartridge 200 should be delivered. At that time, the installed cartridge 200 should have about a week of use left. One could keep the installed cartridge for the extra week before rotating in the backup cartridge, designating the newly delivered cartridge as the backup. Alternatively, one could replace the installed cartridge with the backup cartridge, designate the newly delivered cartridge as the backup, and send the consumed cartridge to be remanufactured at the time of delivery. For the sake of simplicity, this example will immediately replace the installed cartridge. For week 6, there should be no need to deliver cartridge 203 since the one installed in printer 103 should have four weeks of use left, while the one installed in printer 103′ should have five weeks of use left. Thus, back up cartridge 203 should be sufficient to contend with unexpected consumption for at least one more cycle.

For client 22, on Monday of week 10, a cartridge 200 and two cartridges 203 are delivered. The new cartridge 200 replaces the backup cartridge 200 which replaces the installed cartridge 200 which is collected for remanufacturing. The backup cartridge 203 replaces the cartridge installed in printer 103 which should be substantially exhausted. Once again there are alternative scenarios for the cartridge in printer 103′ which should have about a week of use left. That cartridge can be immediately replaced with one of the new cartridges or can remain in the printer for anther week. For the sake of simplicity, it is immediately replaced and the remaining new cartridge becomes the backup. For client 22, the delivery times alternate between deliveries of only one cartridge 200 and deliveries of one cartridge 200 and two cartridges 203.

In another embodiment, the cartridges are replaced regardless of whether they are exhausted or not. The rate of consumption is measured by weighing the cartridges before and after use, and the business is charged only based upon the pro rata use of the ink or toner.

For the self-service kiosk, client 24, one would assign a weekly delivery schedule, which, for purposes of this example, is also assigned to Monday. However, based upon the historical turnover of cartridges, each week should only require the delivery of 4 units of cartridge 200; 1 unit of cartridge 202; 1 unit of cartridge 203; and 8 units of cartridge 204. It should be noted that the units of cartridge 202 and 203 though made available are not necessarily stocked since consumption of these cartridges are relatively low. In an alternative embodiment, the kiosk would transmit the sale of each cartridge to the scheduling computer, so that the technician would know exactly how many of each type of cartridges are needed. In yet another embodiment, the kiosk would have a receptacle for consumed cartridges. As a further alternative, depositing a cartridge for recycling could provide a discount on the purchase of the next cartridge.

Because of the overlaps in the needs of each client, scheduling computer 10 can provide for an efficient schedule for the remanufacture and delivery of cartridges to, in this example, all three clients. Ignoring the initial deliveries (weeks 1-2), on weeks 3, 5, 8, 9, 11, 12 15, 17, 20 and 21, only client 24 needs to be restocked with 4 units of cartridge 200; 1 unit of cartridge 202; 1 unit of cartridge 203; and 8 units of cartridge 204. However, on weeks 4, 7, 13, 16 and 19, client 24 needs to be restocked with 4 units of cartridge 200; 1 unit of cartridge 202; 1 unit of cartridge 203; and 8 units of cartridge 204, while client 20 needs to be restocked with 1 unit of cartridge 200 and 1 unit of cartridge 202. Thus, prior to Monday of those weeks, the scheduling computer orders 5 units of cartridge 200; 2 unit of cartridge 202; 1 unit of cartridge 203; and 8 units of cartridge 204 and the technician visits both clients 20 and 24 to deliver the cartridges in one trip.

Further, on weeks 6, 14 and 18, the needs of client 22 and 24 also overlap. However as indicated above, the rotation for client 22 does not produce the same delivery each time. On weeks 6 and 14, only one unit of cartridge 200 for client 22 is added to the requirements of client 24. On week 18, one cartridge 200 and two cartridges 203 for client 22 are added to the cartridges needed for client 24. As shown above, the combined requirements can be ordered and delivered efficiently.

Moreover, on weeks 10 and 22, the needs of all three clients overlap. However, client 22 only requires one unit of cartridge 200 on week 22 while it needs one cartridge 200 and two cartridges 203 on week 10. Thus, prior to week 10, the scheduling computer orders 6 units of cartridge 200 (1 for each of clients 20 and 22 and 4 for client 24); 2 unit of cartridge 202 (1 for client 20 and 1 for client 24); 3 unit of cartridge 203 (2 for client 22 and 1 for client 24); and 8 units of cartridge 204 (all for client 24). Prior to week 22, the scheduling computer orders 6 units of cartridge 200 (1 for each of clients 20 and 22 and 4 for client 24); 2 unit of cartridge 202 (1 for client 20 and 1 for client 24); 1 unit of cartridge 203 (for client 24); and 8 units of cartridge 204 (all for client 24). In each case, the technician visits each client to deliver their cartridges on the following Monday.

Although shown in the context of only three clients, as clients are added, they are slotted to particular frequencies, particular flights and particular days of the week, depending upon their particular cartridge requirements. Through the scheduling program, the ordering and delivery of cartridges benefit from synergistic needs and economies of scale, such that the cost of production and delivery decreases on a per client basis as the client base grows.

Finally, all references, including any recited priority document, cited herein are hereby incorporated by reference. While the present invention has been described in considerable detail by the illustrated examples, it will be obvious to those having ordinary skilled in the art that alterations may be made without departing from the concept and scope of the present invention as described in the following claims.

I claim:

1. A system for distributing an ink cartridge to a business comprising:
a) a computer comprising a software program capable of calculating a schedule for obtaining and delivering the ink cartridge;
b) a cartridge maker capable of receiving an order for the ink cartridge from the computer; and
c) a delivery channel capable of delivering the ink cartridge to the business,
wherein data regarding a printer used by the business, and a rate that the ink cartridge for the printer is consumed is entered into the computer for the software program to calculate a schedule for making and delivering the ink cartridge such that the schedule assigns a frequency of replacement and a rotational time of cartridge replacement to the business.

2. The system of claim 1, further comprising a distribution center capable of transmitting the order for the ink cartridge from the computer to the cartridge maker and providing the delivery channel for delivering the ink cartridge to the business.

3. The system of claim 1, wherein the cartridge maker is a cartridge remanufacturer that recycles used cartridges.

4. The system of claim 1, wherein the cartridge maker is an OEM that manufactures new cartridges.

5. The system of claim 1, wherein the cartridge maker is selected from the group consisting of a cartridge remanufacturer that recycles used cartridges, an OEM that manufactures new cartridges, and a combination thereof.

6. The system of claim 2, wherein the software calculates a schedule based upon a 24 week schedule having a rotational frequency of 1, 2, 3, 4, 6, 8, 12 or 24 weeks.

7. The system of claim 2, further comprising a self-service kiosk capable of providing cartridges 24 hours a day and seven days a week.

8. The system of claim 1, wherein data from the business is transmitted to the computer through wireless electronic connections.

9. The system of claim 2, wherein data from the kiosk is monitored in real time and the computer adjust the manufacture and delivery schedule in accordance with actual cartridge consumption at the kiosk.

10. The system of claim 1, wherein data from the business is acquired by a technician and entered into the computer manually.

11. The system of claim 2, wherein the kiosk is capable of accepting a used cartridge and providing a price discount on the purchase of the ink cartridge.

12. A method for distributing an ink cartridge to a business comprising:
a) conducting a survey of a printer used by the business and a rate that the ink cartridge is consumed by the printer;
b) entering data from the survey into a computer comprising a software program capable of calculating a schedule for obtaining and delivering the ink cartridge;
c) calculating a schedule for making and delivering the ink cartridge such that the schedule assigns a frequency of replacement and a rotational time of replacement to the business;
d) ordering the ink cartridge from a cartridge maker so that the ink cartridge can be deliver to the business according to a time provided by the schedule; and
e) delivering the ink cartridge to the business at the time provided by the schedule.

13. The method of claim 12, wherein the schedule is a 24 week schedule having a frequency rotation of 1, 2, 3, 4, 6, 8, 12 or 24 weeks.

14. The method of claim 12, wherein data from the survey is transmitted through a hardwire electronic connection with the computer.

15. The method of claim 12, wherein data from the survey is transmitted by a technician who manually enters the data into the computer.

16. The method of claim 12, wherein the schedule is transmitted to a distribution center which orders the ink cartridge from the cartridge maker, receives the ink cartridge from the cartridge maker, and delivers the ink cartridge to the business.

17. The method of claim 12, wherein the schedule is transmitted to a distribution center which orders the ink cartridge from the cartridge maker who delivers the ink cartridge to the business.

18. The method of claim 16, wherein the ink cartridge is delivered by a technician.

19. The method of claim 16, wherein the ink cartridge is delivered by a commercial parcel delivery service.

20. The method of claim 12, further comprising the delivery of the ink cartridge to a kiosk capable of providing cartridges 24 hours a day and seven days a week that can be accessed by the business.
